(19) United States
(12) Patent Application Publication
(10) Pub. No.: US 2011/0179114 A1
(43) Pub. Date: Jul. 21, 2011

(54) User communication analysis systems and methods

(75) Inventors: Venkatachari Dilip, Cupertino, CA (US); Arjun Jayaram, Fremont, CA (US); Ian Eslick, San Francisco, CA (US); Vivek Seghal, San Jose, CA (US)

(73) Assignee: Compass Labs, Inc., San Jose, CA (US)

(21) Appl. No.: 12/930,784

(22) Filed: Jan. 14, 2011

Related U.S. Application Data
(60) Provisional application No. 61/295,645, filed on Jan. 15, 2010.

(51) Int. Cl. G06F 15/16

(52) U.S. Cl. 709/204

(57) ABSTRACT

Analysis of user communication is described. In one aspect, multiple online social interactions are identified. Multiple topics are extracted from those online social interactions. Based on the extracted topics, the system determines an intent associated with a particular online social interaction.

### RELATED APPLICATIONS

This application claims the benefit of U.S. Provisional Application No. 61/295,645, filed Jan. 15, 2010, the disclosure of which is incorporated by reference herein.

### BACKGROUND

Communication among users via online systems and services, such as social media sites, blogs, microblogs, and the like is increasing at a rapid rate. These communication systems and services allow users to share and exchange various types of information. The information may include questions or requests for information about a particular product or service, such asking for opinions or recommendations for a particular type of product. The information may also include user experiences or a user evaluation of a product or service. In certain situations, a user is making a final purchase decision based on responses communicated via an online system or service. In other situations, the user is not interested in making a purchase and, instead, is merely making a comment or reporting an observation.

To support users of online systems and services, it would be desirable to provide an analysis system and method that determines an intent associated with particular user communications.

### BRIEF DESCRIPTION OF THE DRAWINGS

Similar reference numbers are used throughout the figures to reference like components and/or features.

FIG. 1 is a block diagram illustrating an example environment capable of implementing the systems and methods discussed herein.

FIG. 2 is a block diagram illustrating various components of a topic extractor.

FIG. 3 is a block diagram illustrating operation of an example index generator.

FIG. 4 is a block diagram illustrating various components of an intent analyzer.

FIG. 5 is a block diagram illustrating various components of a response generator.

FIG. 6 is a flow diagram illustrating an embodiment of a procedure for collecting data.

FIG. 7 is a flow diagram illustrating an embodiment of a procedure for performing intent analysis.

FIG. 8 is a flow diagram illustrating an embodiment of a procedure for classifying words and phrases.

FIG. 9 is a flow diagram illustrating an embodiment of a procedure for generating a response.

FIG. 10 illustrates an example cluster of topics.

FIG. 11 is a block diagram illustrating an example computing device.

### DETAILED DESCRIPTION

The systems and methods described herein identify an intent (or predict an intent) associated with an online user communication based on a variety of online communications. In a particular embodiment, the described systems and methods identify multiple online social interactions and extract one or more topics from those online social interactions. Based on the extracted topics, the systems and methods determine an intent associated with a particular online social interaction. Using this intent, a response is generated for a user that created the particular online social interaction. The response may include information about a product or service that is likely to be of interest to the user.

Particular examples discussed herein are associated with user communications and/or user interactions via social media web sites/services, microblogging sites/services, blog posts, and other communication systems. Although these examples mention “social media interaction” and “social media communication”, these examples are provided for purposes of illustration. The systems and methods described herein can be applied to any type of interaction or communication for any purpose using any type of communication platform or communication environment.

Additionally, certain examples described herein discuss the generation of a response to a user based on a particular user interaction or user communication. In other embodiments, a response may not be immediately generated for the user. A response may be generated at a future time or, in some situations, no response is generated for a particular user interaction or user communication. Further, a particular response may be stored for communication or presentation to a user at a future time.

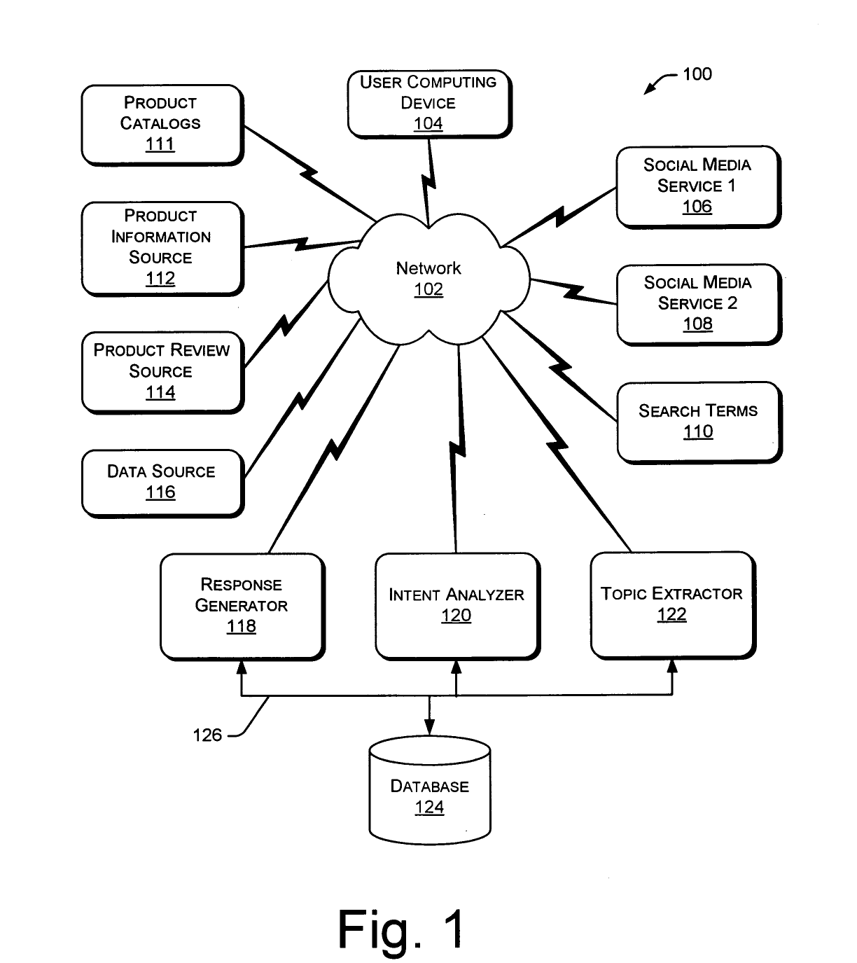

FIG. 1 is a block diagram illustrating an example environment 100 capable of implementing the systems and methods discussed herein. A data communication network 102, such as the Internet, communicates data among a variety of internet-based devices, web servers, and so forth. Data communication network 102 may be a combination of two or more networks communicating data using various communication protocols and any communication medium.

The embodiment of FIG. 1 includes a user computing device 104, social media services 106 and 108, one or more search terms (and related web browser applications/systems) 110, one or more product catalogs 111, a product information source 112, a product review source 114, and a data source 116. Additionally, environment 100 includes a response generator 118, an intent analyzer 120, a topic extractor 122, and a database 124. A data communication network or data bus 126 is coupled to response generator 118, intent analyzer 120, topic extractor 122 and database 124 to communicate data between these four components. Although response generator 118, intent analyzer 120, topic extractor 122 and database 124 are shown in FIG. 1 as separate components or separate devices, in particular implementations any two or more of these components can be combined into a single device or system.

User computing device 104 is any computing device capable of communicating with network 102. Examples of user computing device 104 include a desktop or laptop computer, handheld computer, cellular phone, smart phone, personal digital assistant (PDA), portable gaming device, set top box, and the like. Social media services 106 and 108 include any service that provides or supports social interaction and/or communication among multiple users. Example social media services include Facebook, Twitter (and other microblogging web sites and services), MySpace, message systems, online discussion forums, and so forth. Search terms 110 include various search queries (e.g., words and phrases) entered by users into a search engine, web browser application, or other system to search for content via network 102.

Product catalogs 111 contain information associated with a variety of products and/or services. In a particular implementation, each product catalog is associated with a particular industry or category of products/services. Product catalogs 111 may be generated by any entity or service. In a particular embodiment, the systems and methods described herein collect data from a variety of data sources, web sites, social media sites, and so forth, and “normalize” or otherwise arrange the data into a standard format that is later used by other procedures discussed herein. These product catalogs 111 contain information such as product category, product name, manufacturer name, model number, features, specifications, product reviews, product evaluations, user comments, price, price category, warranty, and the like. As discussed herein, the information contained in product catalogs 111 use useful in determining an intent associated with a user communication or social media interaction, and generating an appropriate response to the user. Although product catalogs 111 are shown as a separate component or system in FIG. 1, in alternate embodiments, product catalogs 111 are incorporated into another system or component, such as database 124, response generator 118, intent analyzer 120, or topic extractor 122, discussed below. Product catalogs represent one embodiment of a structure data source which captures information about common references to any entity of interest such as places, events, or people and services.

Product information source 112 is any web site or other source of product information accessible via network 102. Product information sources 112 include manufacturer web sites, magazine web sites, news-related web sites, and the like. Product review source 114 includes web sites and other sources of product (or service) reviews, such as Epinions and other web sites that provide product-specific reviews, industry-specific reviews, and product category-specific reviews. Data source 116 is any other data source that provides any type of information related to one or more products, services, manufacturers, evaluations, reviews, surveys, and so forth. Although FIG. 1 displays specific services and data sources, a particular environment 100 may include any number of social media services 104 and 106, search terms 110 (and search term generation applications/services), product information sources 112, product review sources 114, and data sources 116. Additionally, specific implementations of environment 100 may include any number of user computing devices 104 accessing these services and data sources via network 102.

Topic extractor 122 analyzes various communications from multiple sources and identifies key topics within those communications. Example communications include user posts on social media sites, microblog entries (e.g., “tweets” sent via Twitter) generated by users, product reviews posted to web sites, and so forth. Topic extractor 122 may also actively “crawl” various web sites and other sources of data to identify content that is useful in determining a user's intent and/or a response associated with a user communication. Intent analyzer 120 determines an intent associated with the various user communications and response generator 118 generates a response to particular communications based on the intent and other data associated with similar communications. A user intent may include, for example, an intent to purchase a product or service, an intent to obtain information about a product or service, an intent to seek comments from other users of a product or service, and the like. Database 124 stores various communication information, topic information, topic cluster data, intent information, response data, and other information generated by and/or used by response generator 118, intent analyzer 120 and topic extractor 122. Additional information regarding response generator 118, intent analyzer 120 and topic extractor 122 is provided herein.

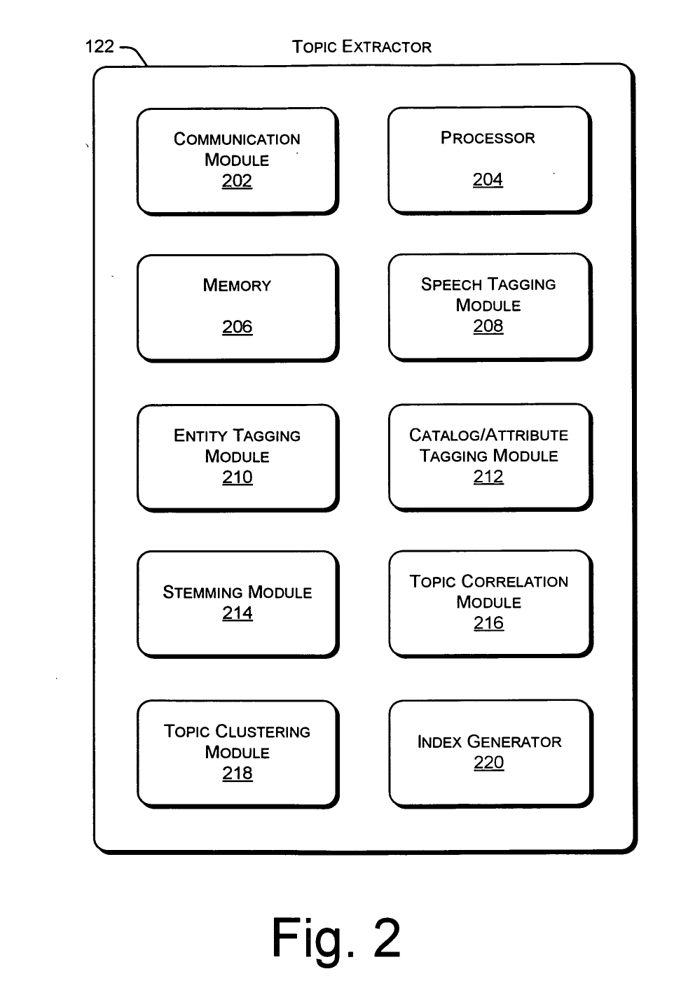

FIG. 2 is a block diagram illustrating various components of topic extractor 122. Topic extractor 122 includes a communication module 202, a processor 204, and a memory 206. Communication module 202 allows topic extractor 122 to communicate with other devices and services, such the services and information sources shown in FIG. 1. Processor 204 executes various instructions to implement the functionality provided by topic extractor 122. Memory 206 stores these instructions as well as other data used by processor 204 and other modules contained in topic extractor 122.

Topic extractor 122 also includes a speech tagging module 208, which identifies the part of speech of the words in a communication that are used to determine user intent associated with the communication and generating an appropriate response. Entity tagging module 210 identifies and tags (or extracts various entities in a communication or interaction. In the following example, a conversation includes “Deciding which camera to buy between a Canon Powershot SD1000 or a Nikon Coolpix S230”. Entity tagging module 210 tags or extracts the following:

Extracted Entities:
Direct Products Type (extracted): Camera
Product Lines: Powershot, Coolpix
Brands: Canon, Nikon
Model Numbers: SD1000, S230

Inferred Entities:
Product Type: Digital Camera (in this example, both models are digital cameras)
Attributes: Point and Shoot (both entities share this attribute)
Prices: 200-400

In this example, the entity extraction process has an initial context of a specific domain, such as “shopping”. This initial context is determined, for example, by analyzing a catalog that contains information associated with multiple products. A catalog may contain information related to multiple industries or be specific to a particular type of product or industry, such as digital cameras, all cameras, video capture equipment, and the like. Once the initial context is determined, references to entities are generated from the catalog or other information source. References are single words or phrases that represent a reference to a particular entity. Once such a phrase has been recognized by the entity tagging module 112, it associated with attributes such as “product types”, “brands”, “model numbers”, and so forth depending on how the words are used in the communication.

Catalog/attribute tagging module 212 identifies (and tags) various information and attributes in online product catalogs, other product catalogs generated as discussed herein, and similar information sources. This information is also used in determining a user intent associated with the communication and generating an appropriate response. In a particular embodiment, the term “attribute” is associated with features, specifications or other information associated with a product or service, and the term “topic” is associated with terms or phrases associated with social media communications and interactions, as well as other user interactions or communications.

Topic extractor 122 further includes a stemming module 214, which analyzes specific words and phrases in a user communication to identify topics and other information contained in the user communication. A topic correlation module 216 and a topic clustering module 218 organize various topics to identify relationships among the topics. For example, topic correlation module 216 correlates multiple topics or phrases that may have the same or similar meanings (e.g., “want” and “considering”). Topic clustering module 218 identifies related topics and clusters those topics together to support the intent analysis described herein. An index generator 220 generates an index associated with the various topics and topic clusters. Additional details regarding the operation of topic extractor 122, and the components and modules contained within the topic extractor, are discussed herein.

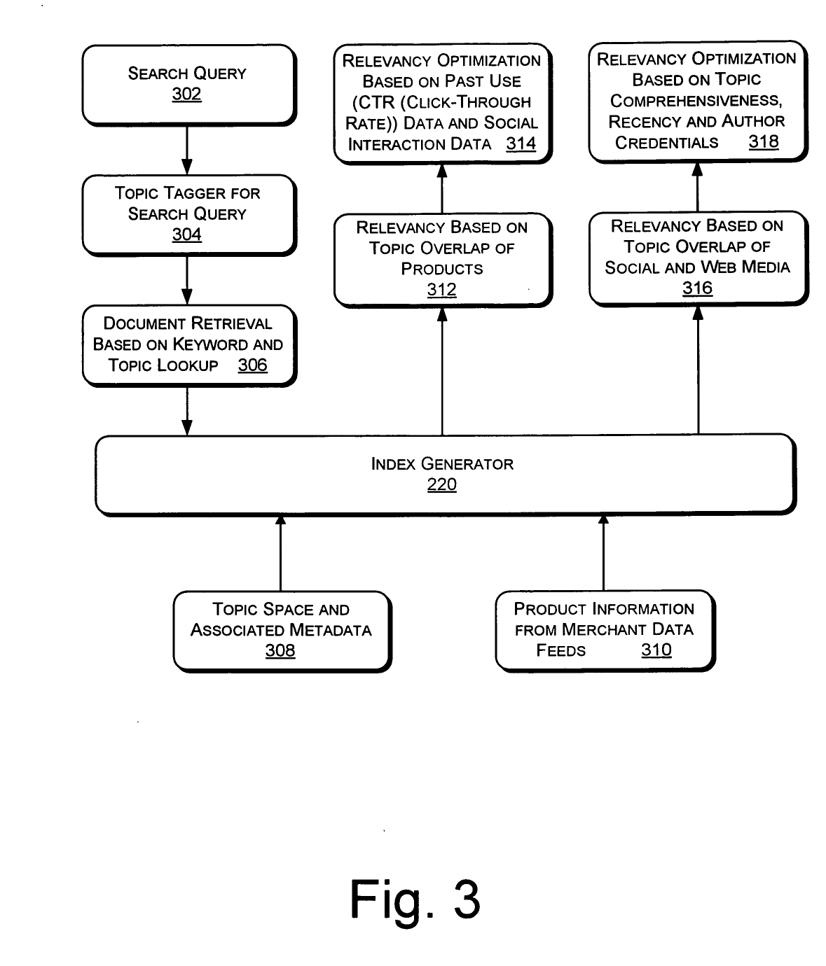

FIG. 3 is a block diagram illustrating operation of an example index generator 220. The procedure generates a “tag cloud” that represents a maximum co-occurrence of particular words from different sources, such as product catalogs, social media content, and other data sources. For example, if the term “Nikon D90” is selected, the process obtains the following information:

1. From a catalog:
12.3 megapixel DX-format CMOS imaging sensor
5.8×AF-S DX Nikkor 18-105mm f/3.5-5.6G ED VR lens included
D-Movie Mode; Cinematic 24 fps HD with sound
3 inch super-density 920,000 dot color LCD monitor
Capture images to SD/SDHC memory cards (not included)

2. From conversations and social media:
Video has poor audio quality and no AF
Fast—focus, frames per second, and card access
I really like the new wide range of ISO settings, especially when coupled with the Auto-ISO setting
I worry that it'll get scratched easily

In particular implementations, additional types of information can be extracted from social media conversations, such as the types of information obtained from the catalog. By extracting data from multiple sources (e.g., social media conversations and catalogs), the systems and methods described herein are able to identify different terms used to refer to common entities. For example, a Nikon Coolpix D30 may also be referred to as a Nikon D30 or just a D30.

Based on the above example, the process can extract words such as “5.8×”, “Cinematic 24 fps”, “12.3 megapixel”, etc. from the catalog(s), while extracting “poor audio quality”, “good ISO setting”, “scratched easily”, etc. from the social media communications. When a user sends a communication “Want a camera with high resolution that can take fast pictures”, the process can perform a more intelligent search based on the information obtained above. The process extracts the important entities from the communication and identifies phrases in the communication that co-occur with these entities from the various data sources, such as the catalog, social media, or other data sources. The results are then “blended” based on, for example, past history. The blending percentage (e.g., blending catalog information vs. social media information) is based on what information (catalog or social media in this example) previous users found most useful based on past click-through rates. For example, if users sending similar communications found responses based on social media results to be most valuable, the “blending” will be weighted more heavily with social media information.

Referring to FIG. 3, index generator 220 receives information associated with a search query 302, a topic tagger 304 and one or more documents retrieved based keyword and topic lookup 306. Index generator 220 also receives topic space information and associated metadata 308 as well as product information from one or more merchant data feeds 310. In a particular embodiment, index generator 220 generates relevancy information based on topic overlap of products 312 and generates optimized relevancy information based on past use data (e.g., past click-through rate) and social interaction data 314. Additionally, index generator 220 generates relevancy information based on topic overlap of social media data and web-based media 316. Index generator 220 also generates optimized relevancy information based on topic comprehensiveness, recency and author credentials 318.

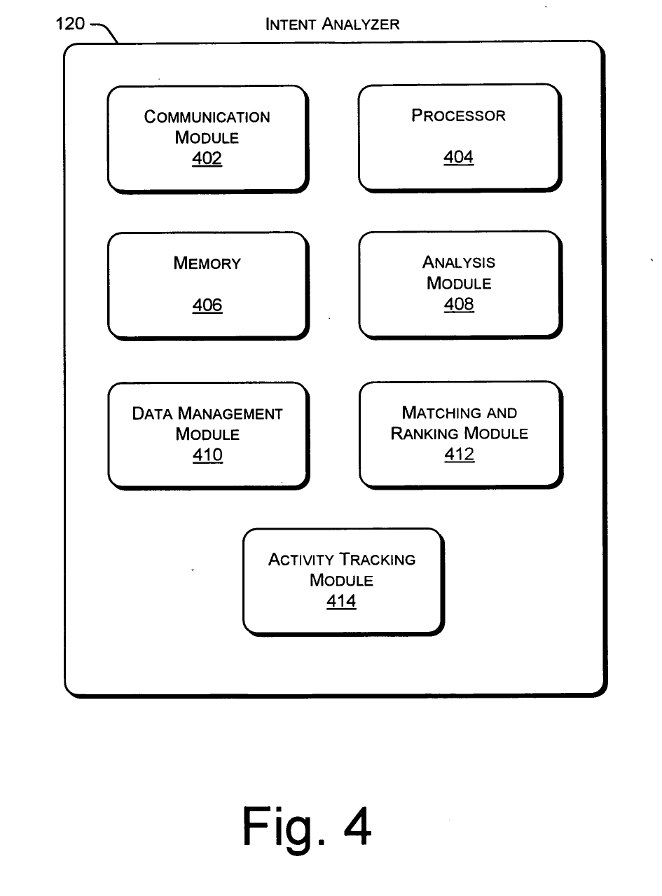

FIG. 4 is a block diagram illustrating various components of intent analyzer 120. Intent analyzer 120 includes a communication module 402, a processor 404, and a memory 406. Communication module 402 allows intent analyzer 120 to communicate with other devices and services, such the services and information sources shown in FIG. 1. Processor 404 executes various instructions to implement the functionality provided by intent analyzer 120. Memory 406 stores these instructions as well as other data used by processor 404 and other modules contained in intent analyzer 120.

Intent analyzer 120 also includes an analysis module 408, which analyzes various words and information contained in a user communication using, for example, the topic and topic cluster information discussed herein. A data management module 410 organizes and manages data used by intent analyzer 120 and stored in database 124. A matching and ranking module 412 identifies topics, topic clusters, and other information that match words and other information contained in a user communication. Matching and ranking module 412 also ranks those topics, topic clusters, and other information as part of the intent analysis process. An activity tracking module 414 tracks click-through rate (CTR), the end conversions on a product (e.g., user actually buys a recommended product), and other similar information. CTR is the number of clicks on a particular option (e.g., product or service offering displayed to the user) divided by a normalized number of impressions (e.g., displays of options). A “conversion” is the number of people who buy a particular product or service. A “conversion percentage” is the number of people buying a product or service divided by the number of people clicking on an advertisement for the product or service.

Atypical goal is to maximize CTR while keeping conversions above a particular threshold. In other embodiments, the systems and methods described herein attempt to maximize conversions. Impression counts are normalized based on their display position. For example, an impression in the 10th position (a low position) is expected to get a lower number of clicks based on a logarithmic scale. When tracking user activity, a typical user makes several requests (e.g., communications) during a particular session. Each user request is for a module, such as a tag cloud, product, deal, interaction, and so forth. Each user request is tracked and monitored, thereby providing the ability to re-create the user session. The system is able to find the page views associated with each user session. From the click data (what options or information the user clicked on during the session), the system can determine the revenue generated during a particular session. The system also tracks repeat visits by the user across multiple sessions to calculate the lifetime value of a particular user. Additional details regarding the operation of intent analyzer 120, and the components and modules contained within the intent analyzer, are discussed herein.

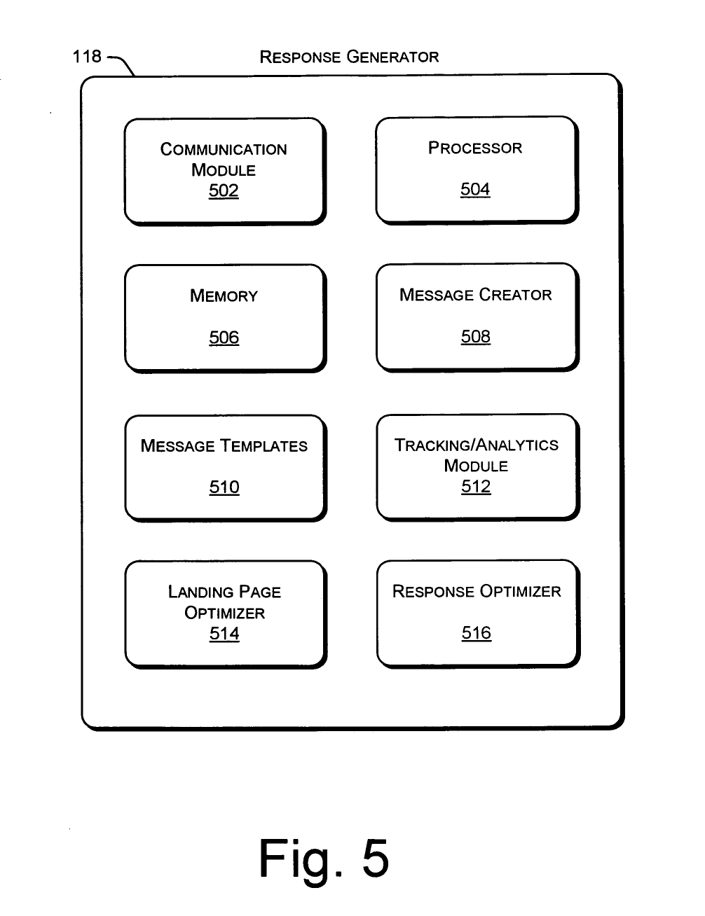

FIG. 5 is a block diagram illustrating various components of response generator 118. Response generator 118 includes a communication module 502, a processor 504, and a memory 506. Communication module 502 allows response generator 118 to communicate with other devices and services, such the services and information sources shown in FIG. 1. Processor 504 executes various instructions to implement the functionality provided by response generator 118. Memory 506 stores these instructions as well as other data used by processor 504 and other modules contained in response generator 118.

A message creator 508 generates messages that respond to user communications and/or user interactions. Message creator 508 uses message templates 510 to generate various types of messages. A tracking/analytics module 512 tracks the responses generated by response generator 118 to determine how well each response performed (e.g., whether the response was appropriate for the user communication or interaction, and whether the response was acted upon by the user). A landing page optimizer 514 updates the landing page to which users are directed based on user activity in response to similar communications. For example, various options presented to a user may be rearranged or re-prioritized based on previous CTRs and similar information. A response optimizer 516 optimizes the response selected (e.g., message template selected) and communicated to the user based on knowledge of the success rate (e.g., user takes action by clicking on a link in the response) of previous responses to similar communications.

In operation, response generator 118 retrieves social media interactions and similar communications (e.g., “tweets” on Twitter, blog posts and social media posts) during a particular time period, such as the past N hours. Response generator 118 determines an intent score, a spam score, and so forth. Message templates 510 include the ability to insert one or more keywords into the response, such as: {$UserName} you may want to try these {$ProductLines} from {$Manufacturer}. At run time, the appropriate values are substituted for $UserName, $ProductLines, and $Manufacturer. Response messages provided to users are tracked to see how users respond to those messages (e.g., how users respond to different versions (such as different language) of the response message).

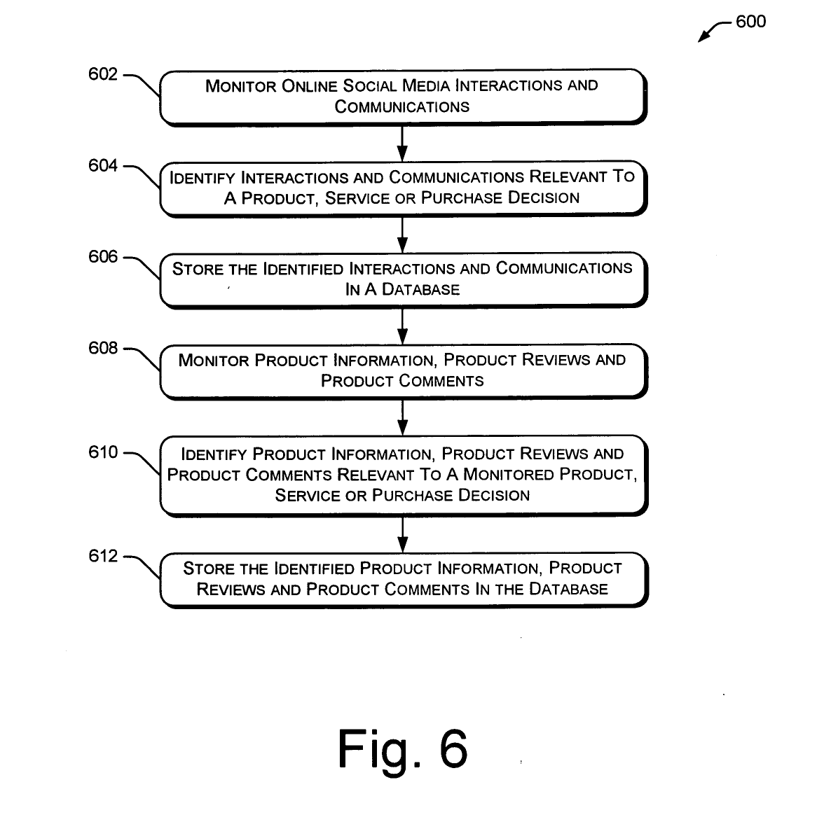

FIG. 6 is a flow diagram illustrating an embodiment of a procedure 600 for collecting data. Initially, the procedure monitors various online social media interactions and communications (block 602), such as blog postings, microblog posts, social media communications, and the like. This monitoring includes filtering out various comments and statements that are not relevant to the analysis procedures discussed herein. The procedure identifies interactions and communications relevant to a particular product, service or purchase decision (block 604). For example, a user may generate a communication seeking information about a particular type of digital camera or particular features that they should seek when shopping for a new digital camera. Procedure 600 continues by storing the identified interactions and communications in a database (block 606) for use in analyzing the interactions and communications, as well as generating an appropriate response to a user that generated a particular interaction or communication.

The procedure of FIG. 6 also monitors product information, product reviews and product comments from various sources (block 608). This information is obtained from user comments on blog posts, microblog communications, and so forth. The procedure then identifies product information, product reviews and product comments that are relevant to a monitored product, service or purchase decision (block 610). For example, a particular procedure may be monitoring digital cameras. In this example, the procedure identifies specific product information, product reviews and product comments that are relevant to buyers or users of digital cameras. The identified product information, product reviews and product comments are stored in the database for future analysis and use (block 612). In one embodiment, the procedure actively “crawls” internet-based content sites for information related to particular products or services, and stores that information in a database along with other information collected from multiple sources.

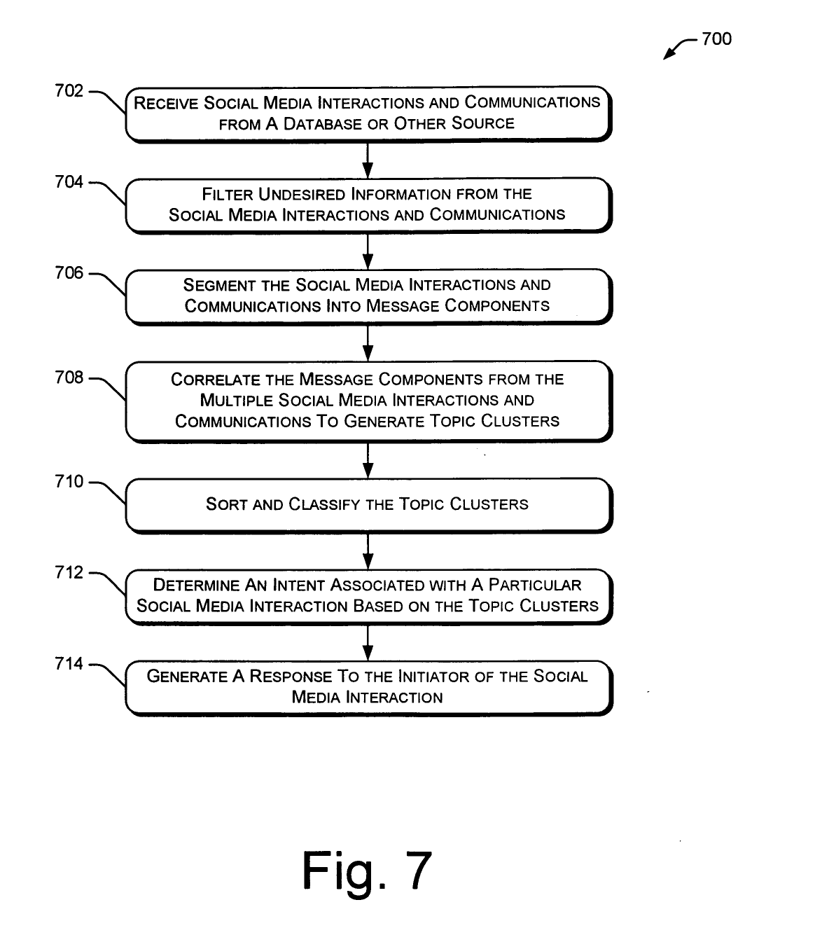

FIG. 7 is a flow diagram illustrating an embodiment of a procedure 700 for performing intent analysis. Initially, the procedure receives social media interactions and communications from the database (e.g., database 124 of FIG. 1) or other source (block 702). In alternate embodiments, the social media interactions and communications are received from a buffer or received in substantially real time by monitoring interactions and communications via the Internet or other data communication network. The procedure filters out undesired information from the social media interactions and communications (block 704). This undesired information may include communications that are not related to a monitored product or service. The undesired information may also include words that are not associated with the intent of a user (e.g., “a”, “the”, and “of”).

Procedure 700 continues by segmenting the social media interactions and communications into message components (block 706). This segmenting includes identifying important words in the social media interactions and communications. For example, words such as “digital camera”, “Nikon”, and “Canon” may be important message components in analyzing user intent associated with digital cameras. The message components are then correlated with other message components from multiple social media interactions and communications to generate topic clusters (block 708). The message components may also be correlated with information from other information sources, such as product information sources, product review sources, and the like. The correlated message components are formed into one or more topic clusters associated with a particular topic (e.g., a product, service, or product category).

The various topic clusters are then sorted and classified (block 710). The procedure may also identify products or services contained in each topic cluster. Each communication or interaction is classified in one or more ways, such as using a Maximum entropy classifier based on occurrences of words in the dictionary, or a simple count of words in a product catalog. Based on the number of occurrences or word counts, each communication or interaction is assigned one or more category scores. A Maximum entropy classifier is a model used to predict the probabilities of different possible outcomes. Procedure 700 then determines an intent associated with a particular social media interaction based on the topic clusters (block 712) as well as the corresponding product or service. Based on the determined intent, a response is generated and communicated to the initiator of the particular social media interaction (block 714).

By arranging data into topic clusters, different terms that have similar meanings can be grouped together to provide a better understanding of user intent from social media interactions and communications. For example, two people may be looking for a “product review” of a particular product. One person uses the term “review” for product review and another person might use “buyers guide” in place of product review. Both of these terms should be grouped together as having a common user intent. By analyzing many such interactions and communications, the system can build a database of terms and topics that are correlated and indexed.

In a particular embodiment, when determining user intent based on a particular social media interaction or communication, the interaction or communication is assigned to one of several categories. Example categories include “purchase intent”, “opinions”, “past purchasers”, and “information seeker”.

In another embodiment, the procedure of FIG. 7 suggests a user's likelihood to purchase a product or service. This likelihood is categorized, for example, as 1) ready to buy; 2) most important attributes to the user; and 3) what is the user likely to buy? This categorization is used in combination with the topics (or topic clusters) discussed herein to generate a response to the user's social media interaction or communication.

In certain embodiments, the systems and methods described herein identify certain users or content sources as “experts”. An “expert” is any user (or content source) that is likely to be knowledgeable about the topic. For example, a user that regularly posts product reviews on a particular topic/product that are valuable to other users is considered an “expert” for that particular topic/product. This user's future communications, reviews, and so forth related to the particular topic/product are given a high weighting.

The intent analysis procedures discussed herein use various machine learning algorithms, machine learning processes, and classification algorithms to determine a user intent associated with one or more user communications and/or user interactions. These algorithms and procedures identify various statistical correlations between topics, phrases, and other data. In particular implementations, the algorithms and procedures are specifically tailored to user communications and user interactions that are relatively short and may not contain “perfect” grammar, such as short communications sent via a microblogging service that limits communication length to a certain number of words or characters. Thus, the algorithms and procedures are optimized for use with short communications, sentence fragments, and other communications that are not necessarily complete sentences or properly formed sentences. These algorithms and procedures analyze user communications and other data from a variety of sources. The analyzed data is stored and categorized for use in determining user intent, user interest, and so forth. As data is collected over time regarding user intent, user responses to template messages, and the like, the algorithms and procedures adapt their recommendations and analysis based on the updated data. In a particular embodiment, recent data is given a higher weighting than older data in an effort to give current trends, current terms and current topics higher priority. In one embodiment, various grammar elements are grouped together to determine intent and other characteristics across one or more users, product categories, and the like.

In a particular embodiment, the systems and methods perform speech tagging of a message or other communication. In this embodiment, the speech tagging identifies nouns, verbs and qualifiers within a communication. A new feature is created in the form of Noun-Qualifier-Verb-Noun. For example, a communication “I am looking to buy a new camera” creates “I-buy-camera”. And, a communication “I don't need a camera” creates “I-don't-need-camera”. If a particular communication contains multiple sentences, the above procedure is performed to create a new feature for each sentence.

In a particular implementation, different machine learning techniques or procedures are used for determining intent. In this implementation, the intent determination is “tuned” for each vertical market or industry, thereby producing separate machine learning models and data for each vertical market/industry. In this situation, several steps are performed when determining intent: 1. determine which vertical/category the user communication (e.g., “document”) belongs to; 2. extract the entities corresponding to the category; 3. replace the entities with a generic place holder; 4. filter out messages having no value; 5. apply a first level intent determination model for that vertical/category to make a binary determination of whether there is or isn't intent; and 6. apply further models to determine the level of intent for the particular user communication. The systems and methods use a combination of entity extraction and semi-supervised learning to determine intent.

The semi-supervised learning portion provides the following data to help with model generation: 1. labeled data for each category of intent/no intent; and 2. dictionary of terms for catalogs. From the labeled data, a model is generated using different classification techniques. Maximum entropy works well for certain categories, SVM (support vector machine) works better for other categories. An SVM is a set of related supervised learning procedures or methods used to classify information. Feature selection is the next step where a user reviews some of the top frequency features and helps in directing the algorithm. The model is then tested for precision and recall for various user communications, user interactions, and other documents.

These models try to make the binary classification of Yes or No. In some categories like accessories, the systems and methods use multiple classifiers and attempt to identify a majority rule. If the models classify the document as ‘YES’ (has intent), the procedure will try to use a multi-class classifier like Maximum entropy to determine the level of intent. This is a useful score that is referred to as an “intent score”. The systems and methods also use entity scores to determine the level of intent.

Entity extraction is utilized, for example, in the following manner. From the dictionary of terms and the received user communications/documents, the systems and methods determine an entity that the user is talking about. This entity may be a product, product category, brand, event, individual, and so forth. Next, the systems and methods identify the product line model numbers, brands, and other data that are being used by the user in the communication/document. This information is tagged for the user communication/document. By tagging various parts of speech, the systems and methods can determine the verbs, adverbs and adjectives for the entities.

Once a user communication/document has been scored regarding intent, the entity tagging helps in identifying the level of intent. Users typically start to think of products from product types, then narrow down to a brand and then a model number. So, if a user mentions a model number and has intent, the user is likely to have high intent because they have focused their communication on a particular model number and they show an interest in the product.

The systems and methods then tune the intent determination and/or intent scoring algorithm based on user feedback, and cluster scored user communications/documents that have similar user feedback. This is done using a clustering algorithm such as KNN (k-nearest neighbor algorithm), which is a process that classifies objects based on the closest training example. The systems and methods then consider the user feedback from the engagement metrics on the site and the actual conversion (e.g., product purchases by the user). An objective function is used to maximize conversions for user communications/documents with intent. Based on this function, the weights of the scoring function are further tuned.

In specific embodiments, the systems and methods identify the entities and the intent (as described herein) from the user communications/documents. Based on this identification, the user communications/documents are clustered and new user communications/documents are scored. The new user communications/documents are then assigned to a cluster and related communications/documents are identified and displayed based on the cluster assignment.

When aggregating data from multiple sources, the algorithms selected are dependent on the sources. For example, the classification algorithm for intent will be different for discussion forums vs. microblog postings, etc.

Scores are normalized across multiple sources. For long user communications/documents, the systems and methods identify more metadata, such as thread, date, username, message identifier, and the like. After the scores are normalized, the data repository is independent of the source.

In a particular implementation, multiple response templates need to be matched to user communications/documents. Each user communication/document is marked for intent, levels and entities. The systems and methods consider past data to determine the templates that are likely to be most effective. These systems and methods also need to be careful of over exposure. This is similar to “banner burn out”, where systems cannot re-run the most effective banner advertisements every time as the effectiveness will eventually decline. There are multiple dimensions to consider for optimization such as level of intent, category, time of day, profile of user, recency of the user communication/document, and so forth. The objective function maximizes the probability of a click-in (user selection) for the selected response template.

When attempting to determine a user's intent to purchase a particular product or service based on a social media communication (or other communication), two different types of information are useful. First, the product or service identified in the social media communication is useful in determining an intent to buy the product or service. The second type of information is associated with a user's intent level (e.g., whether they are gathering information or ready to buy a particular product or service). In particular embodiments, these two types of information are combined to analyze social media communications and determine an intent to purchase a product.

For example, a communication “I am going shopping for shorts” identifies a particular product category, such as “clothing” or “apparel/shorts”. This communication also identifies a high level of intent to purchase. However, a second communication “This stuff is really short” uses a common word (i.e., “short”), but the second communication has no product category because “short” is not referring to a product. Further, this second communication lacks any intent to purchase a product.

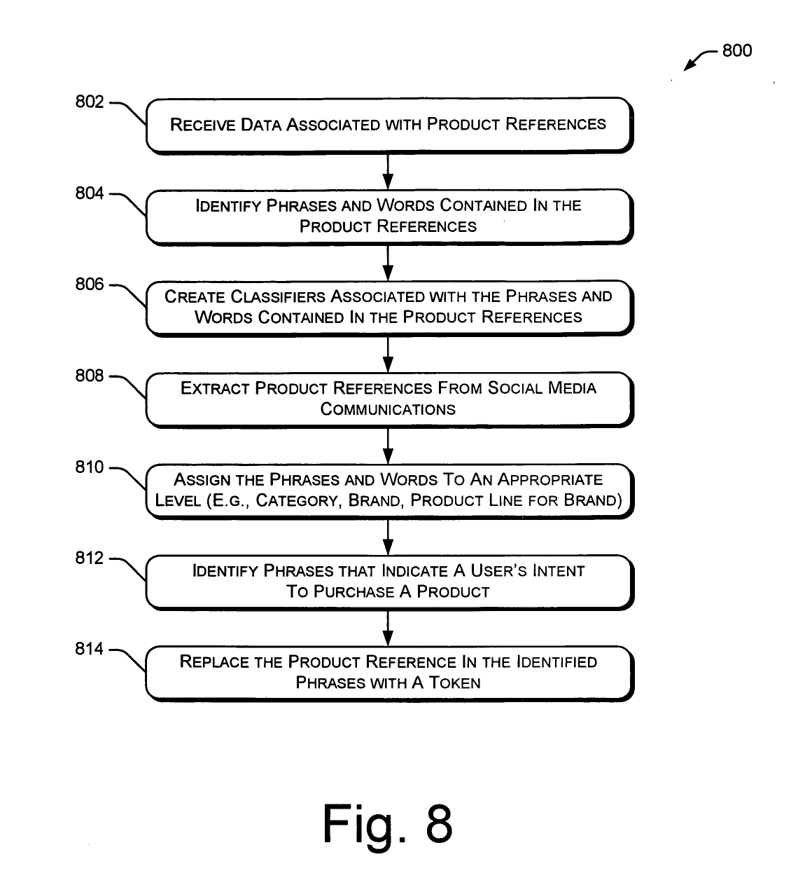

FIG. 8 is a flow diagram illustrating an embodiment of a procedure 800 for classifying words and phrases. This procedure is useful in determining whether a particular communication identifies an intent to purchase a product. Procedure 800 is useful in classifying words and/or phrases contained in various social media communications, catalogs, product listings, online conversations and any other data source.

Initially, procedure 800 receives data associated with product references from one or more sources (block 802). The procedure then identifies words and phrases contained in those product references (block 804). In a particular implementation, these words and phrases are identified by generating multiple n-grams, which are phrases with a word size less than or equal to n. These n-grams can be created by using overlapping windows, where each window has a size less than or equal to n and applying the window to the title or description of a product in a source, such as a product catalog or product review. Phrases and words are also identified by searching for brand references in the title and identifying words with both numbers and alphabet characters, which typically identify a specific product number or model number. Additionally, phrases and words are located by identifying words located near numbers, such as “42 inch TV”. In this example, “42 inch” is a feature of the product and “TV” is the product category. The various phrases and words can be combined in different arrangements to capture the various ways that the product might be referenced by a user.

Procedure 800 continues by creating classifiers associated with the phrases and words contained in the product references (block 806). These classifiers are also useful in filtering particular words or phrases. For example, the procedure may create a classifier associated with a particular product category using the phrases and words identified above. This classifier is useful in removing phrases and words that do not classify to a small number of categories with a high level of confidence (e.g., phrases that are not good discriminators).

The procedure then extracts product references from social media communications (block 808). This part of the procedure determines how products are actually being referred to in social media communications. The phrases and words used in social media communications may differ from the phrases and words used in catalogs, product reviews, and so forth. In a particular implementation, messages are extracted from social media communications based on similar phrases or words. For example, the extracted messages may have high mutual information with the category. Mutual information refers to how often an n-gram co-occurs with phrases within a particular category, and how often the n-gram does not occur with n-grams in other categories. Old phrases are filtered out as new phrases are identified in the social media communications. This process is repeated until all relevant phrases are extracted from the social media communications.

Procedure 800 continues by assigning the phrases and words to an appropriate level (block 810), such as “category”, “brand”, or “product line for brand”. For example, phrases that are common to a few products may be associated with a particular product line. Other phrases that refer to many or all products for a particular brand may be re-assigned to the “brand” level. Phrases that are generic for a particular category are assigned to the “category” level. In a particular embodiment, if a phrase belongs to three or more products, it is assigned to the “product line” level.

The procedure continues by identifying phrases that indicate a user's intent to purchase a product (block 812). Product information, such as a product line, contained in a particular communication is useful in determining an intent to purchase a product. For example, a particular communication may say “I want a new Canon D6”, which refers to a particular model of Canon camera (the D6). Procedure 800 then replaces the product reference in the identified phrases to a token (block 814). In the above example, “Canon D6” is replaced with a token “<REF>” (or <Product-REF>). Thus, the phrase becomes “I want a new <REF>”. In this example, the intent analysis procedures can use the phrase “I want a new <REF>” with any number of products, including future products that are not yet available. This common language construct reduces the number of phrases managed and classified by the systems and methods described herein. Additionally, the common language construct helps in removing unnecessary data and allows the systems and methods to focus on the intent by looking at the language construct instead of the product reference.

When a new user communication includes “I want a new <REF>”, the system knows that the user has a strong intent to buy the product <REF>. In another embodiment, multiple types of tokens such as “<PROD>” or “<BRAND>” are used to allow for variations in the way that users talk about different types of products. This avoids ambiguity in certain phrases such as “I like to buy the Canon D6” and “I like to buy Canon” which have different levels of intent (the former being much more likely to result in a purchase than the later). The phrases in this embodiment would become “I like to buy <PROD>” and “I like to buy <BRAND>” respectively.

In a particular embodiment, an intent-to-purchase score is calculated that indicates the likelihood that the user is ready to buy a product. For example, the intent-to-purchase score may range from 0 to 1 where the higher the score, the more likely the user is to purchase the product identified in a communication. The score may change as a user goes through different stages of the purchasing process. For example, when the user is performing basic research, the score may be low. But, as the user begins asking questions about specific products or product model numbers, the score increases because the user is approaching the point of making a purchase.

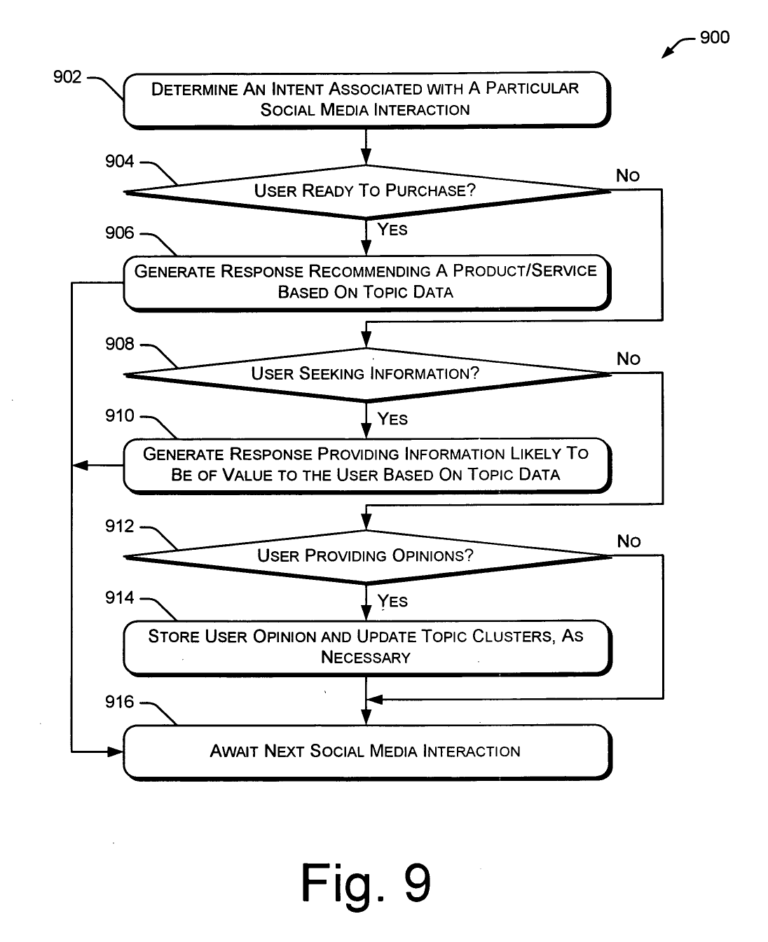

FIG. 9 is a flow diagram illustrating an embodiment of a procedure 900 for generating a response. After determining an intent associated with a particular social media interaction (block 902), the procedure determines whether the user is ready to purchase a product or service (block 904). If so, the procedure generates a response recommending a product/service based on topic data (block 906). If the user is not ready to purchase, procedure 900 continues by determining whether the user is seeking information about a product or service (block 908). If so, the procedure generates a response that provides information likely to be of value to the user based on topic data (block 910). For example, the information provided may be based on responses to previous similar users that were valuable to the previous similar users. If the user is not seeking information, the procedure continues by determining whether the user is providing their opinions about a particular product or service (block 912). If so, the procedure stores the user opinion and updates the topic data and topic clusters, as necessary (block 914). The procedure then awaits the next social media interaction or communication (block 916).

A particular response can be general or specific, depending on the particular communication to which the response is associated. For example, if the particular communication is associated with a specific model number of a digital camera, the response may provide specific information about that camera model that is likely to be of value to the user. For example, a specific response might include “We have found that people considering the ABC model 123 camera are also interested in the XYZ model 789 camera.” If the particular communication is associated with ABC digital cameras in general, the response generated may provide general information about ABC cameras and what features or models were of greatest interest to similar users. For example, a general response might include “We have found that people feel ABC cameras are compact, have many features, but have a short battery life.”

In particular embodiments, the intent analysis and response generation procedures are continually updating the topics, topic clusters, and proposed responses. The update occurs as users are generating interactions and communications with different terms/topics. Also, data is updated based on how users handle the responses generated and communicated to the user. If users consistently ignore a particular response, the weighting associated with that response is reduced. If users consistently accept a particular response (e.g., by clicking a link or selecting the particular response from a list of multiple responses), the weighting associated with that response is increased. Additionally, information that is more recent (e.g., recent product reviews or customer opinions) are given a higher weighting than older information.

When generating a response to a user, it is typically tailored to the user based on the user's social media interaction or communication. By looking at the topics/topic clusters based on multiple social media interactions and communications by others, a response is generated based on topics/topic clusters that are closest to the particular user communication. Example responses include “People like you have usually purchased a Nikon or Canon camera. Consider these cameras at (link)” and “People like you have tended to like cameras with the ability to zoom and with long battery life.”

In a particular embodiment, the methods and systems described herein generate a response to a user based on a determination of the user's interest (not necessarily intent), which is based on the topics or phrases contained in the user's communication. If a user's communication includes “I need a new telephoto lens for my D100”, the systems and methods determine that the user is interested in digital camera lenses. This determination is based on terms in the communication such as “telephoto lens” and “D100”. By analyzing these terms as well as information contained in product catalogs and other data sources discussed herein, the systems and methods are able to determine that “telephoto lens” is associated with cameras and “D100” is a particular model of digital camera manufactured by Nikon. This knowledge is used to identify telephoto lenses that are suitable for use with a Nikon D100 camera. Information regarding one or more of those telephoto lenses is then communicated to the user. Thus, rather than merely generating a generic response associated with digital cameras or camera lenses, the response is tailored to the user's interest (telephoto lenses for a D100). This type of targeted response is likely to be valuable to the user and the user is likely to be more responsive to the information (e.g., visiting a web site to buy one of the recommended telephoto lenses or obtain additional information about a lens).

When generating a response to a user, the systems and methods described herein select an appropriate message template (or response template) for creating the response that is communicated to the user. The message template is selected based on which template is likely to generate the best user response (e.g., provide the most value to the user, or cause the user to make a purchase decision or take other action). This template selection is based on knowledge of how other users have responded to particular templates in similar situation (e.g., where users generated similar topics or phrases in their communication). User responses to templates are monitored for purposes of prioritizing or ranking template effectiveness in various situations, with different types of products, and the like.

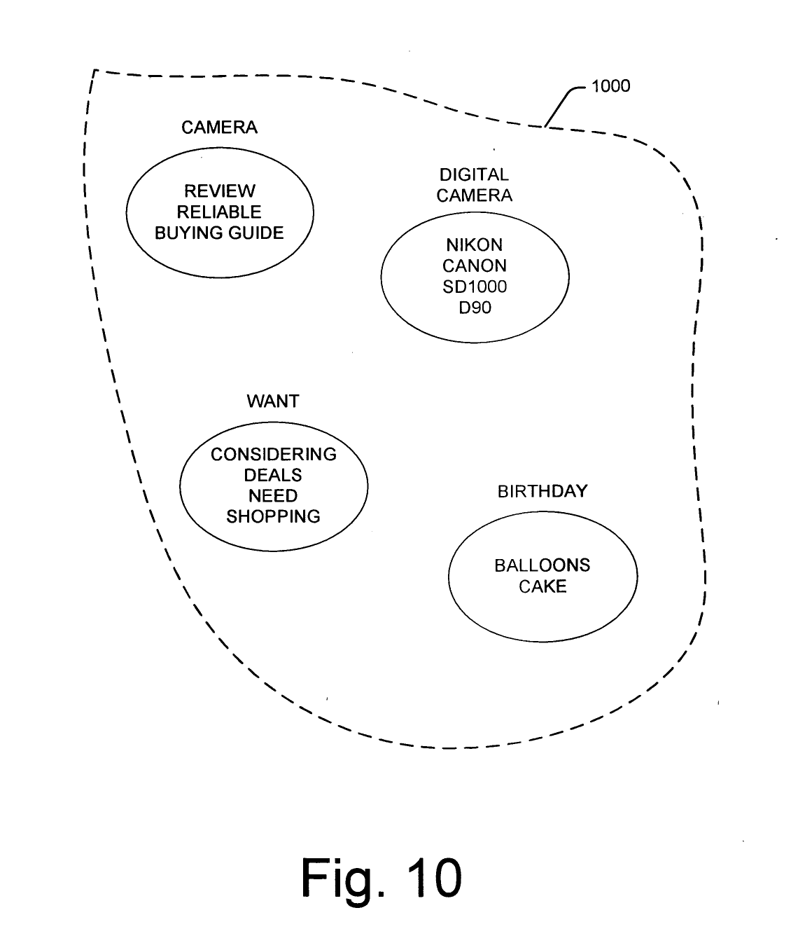

FIG. 10 illustrates an example showing several clusters of topics 1000. In the example of FIG. 10, four topic clusters are shown (Camera, Digital Camera, Want and Birthday). These topic clusters are generated in response to analyzing one or more social media interactions and communications, as well as other information sources. In a particular example, a user communicates a statement “I want a new digital camera for my birthday”. In this example, the words in the statement are used to determine a user intent and generate an appropriate response to the user.

In the example of FIG. 10, the “Camera” topic cluster includes topics: review, reliable, and buying guide. Similarly, the “Digital Camera” topic cluster includes topics: Nikon, Canon, SD1000 and D90. These topics are all related to the product category “digital cameras”. The “Want a <Product>” topic cluster includes topics: considering, deals, needs and shopping. These topics represent different words used by different users to express the same idea. For example, different users will say “considering” and “shopping” to mean the same thing (or show a similar user intent). The “Birthday” topic cluster includes topics: balloons and cake. These topic clusters are regularly updated by adding new topics with high weightings and by reducing the weighting associated with older, less frequently used comments.

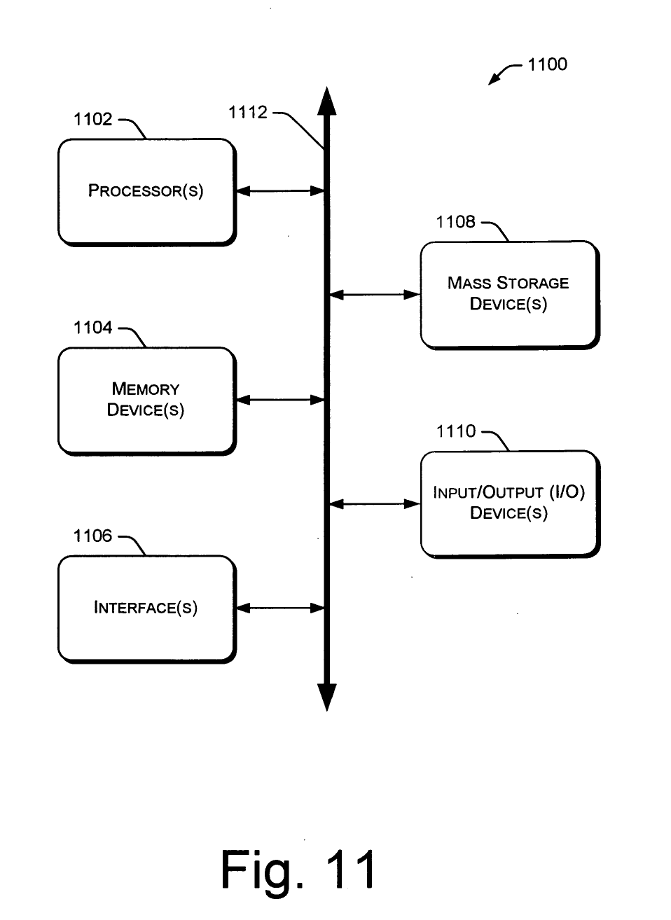

FIG. 11 is a block diagram illustrating an example computing device 1100. Computing device 1100 may be used to perform various procedures, such as those discussed herein. Computing device 1100 can function as a server, a client, or any other computing entity. Computing device 1100 can be any of a wide variety of computing devices, such as a desktop computer, a notebook computer, a server computer, a handheld computer, and the like.

Computing device 1100 includes one or more processor(s) 1102, one or more memory device(s) 1104, one or more interface(s) 1106, one or more mass storage device(s) 1108, and one or more Input/Output (I/O) device(s) 1110, all of which are coupled to a bus 1112. Processor(s) 1102 include one or more processors or controllers that execute instructions stored in memory device(s) 1104 and/or mass storage device(s) 1108. Processor(s) 1102 may also include various types of computer-readable media, such as cache memory.

Memory device(s) 1104 include various computer-readable media, such as volatile memory (e.g., random access memory (RAM)) and/or nonvolatile memory (e.g., read-only memory (ROM)). Memory device(s) 1104 may also include rewritable ROM, such as Flash memory.

Mass storage device(s) 1108 include various computer readable media, such as magnetic tapes, magnetic disks, optical disks, solid state memory (e.g., Flash memory), and so forth. Various drives may also be included in mass storage device(s) 1108 to enable reading from and/or writing to the various computer readable media. Mass storage device(s) 1108 include removable media and/or non-removable media.

I/O device(s) 1110 include various devices that allow data and/or other information to be input to or retrieved from computing device 1100. Example I/O device(s) 1110 include cursor control devices, keyboards, keypads, microphones, monitors or other display devices, speakers, printers, network interface cards, modems, lenses, CCDs or other image capture devices, and the like.

Interface(s) 1106 include various interfaces that allow computing device 1100 to interact with other systems, devices, or computing environments. Example interface(s) 1106 include any number of different network interfaces, such as interfaces to local area networks (LANs), wide area networks (WANs), wireless networks, and the Internet.

Bus 1112 allows processor(s) 1102, memory device(s) 1104, interface(s) 1106, mass storage device(s) 1108, and I/O device(s) 1110 to communicate with one another, as well as other devices or components coupled to bus 1112. Bus 1112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1100, and are executed by processor(s) 1102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A computer-implemented method comprising:
identifying a plurality of online social interactions;
extracting a plurality of topics from the plurality of online social interactions; and
determining an intent associated with a particular online social interaction based on the plurality of topics extracted from the plurality of online social interactions.

2. A method as recited in claim 1 further comprising identifying a relevant product or service for a user communicating the particular online social interaction.

3. A method as recited in claim 2 further comprising communicating a response to the user, wherein the response references the relevant product or service.

4. A method as recited in claim 1 further comprising identifying attributes associated with each of the plurality of topics.

5. A method as recited in claim 4 further comprising associating the identified attributes with online social interactions having common topics.

6. A method as recited in claim 1 wherein extracting a plurality of topics from the plurality of online social interactions includes segmenting the plurality of online social interactions into message components.

7. A method as recited in claim 1 further comprising identifying at least one attribute associated with the plurality of topics.

8. A method as recited in claim 1 further comprising ranking the plurality of topics based on the plurality of online social interactions and other web-available content.

9. A computer-implemented method comprising:
identifying a plurality of online communications;
determining an intent associated with a particular online communication; and
generating a response to a user generating the particular online communication based on the intent associated with the particular online communication.

10. A method as recited in claim 9 wherein generating a response includes identifying a relevant product or service for the user based on the intent associated with the particular online communication.

11. A method as recited in claim 9 further comprising identifying other web-based content related to a topic associated with the plurality of online social interactions.

12. A method as recited in claim 9 wherein the plurality of online communications include online reviews of products or services.

13. A computer-implemented method comprising:
receiving an online social interaction message initiated by a user;
segmenting the online social interaction message into a plurality of message components;
comparing the message components with a plurality of topic clusters;
determining an intent associated with the online social interaction message based on the topic clusters; and
generating a response to the user based on the intent of the online social interaction message.

14. A method as recited in claim 13 wherein the intent includes a readiness to purchase a product or service.

15. A method as recited in claim 13 wherein the intent includes an interest in obtaining information associated with a particular product or service.

16. A method as recited in claim 13 wherein the intent includes user opinions associated with a particular product or service.

17. A method as recited in claim 13 wherein the intent includes purchase activity by the user.

18. A method as recited in claim 13 wherein the topic clusters include product categories.

19. A method as recited in claim 13 wherein the topic clusters include specific product information.

20. A method as recited in claim 13 wherein determining an intent associated with the online social interaction message includes analyzing topic clusters associated with previous online social interaction messages.

21. A method as recited in claim 13 wherein determining an intent associated with the online social interaction message includes analyzing a profile associated with the user.

22. A method as recited in claim 13 wherein determining an intent associated with the online social interaction message includes analyzing previous user social interaction messages.

23. A method as recited in claim 13 wherein segmenting the online social interaction message includes identifying message components associated with a future user purchase decision.

24. A method as recited in claim 13 wherein segmenting the online social interaction message includes identifying message components associated with a user opinion.

25. A method as recited in claim 13 wherein segmenting the online social interaction message includes identifying message components associated with prior user purchases.

26. A method as recited in claim 13 wherein generating a response to the user includes communicating information associated with a particular product or service to the user.

27. A method as recited in claim 13 wherein generating a response to the user includes communicating a product review to the user.

28. A computer-implemented method comprising:
identifying an online communication generated by a user;
extracting at least one topic from the online communication; and
identifying at least one product or product feature likely to be of interest to the user based on the at least one topic extracted from the online communication.

29. A method as recited in claim 28 further comprising communicating a response to the user, wherein the response includes the identified product or product feature.

30. A method as recited in claim 28 further comprising determining an intent associated with the online communication.

31. A method as recited in claim 28 further comprising determining an interest associated with content in the online communication.
